(19) United States
(12) Patent Application Publication
(10) Pub. No.: US 2025/0122774 A1
(43) Pub. Date: Apr. 17, 2025

(54) ALL METAL-TO-METAL CASING PATCH

(71) Applicant: Philip HEAD, Berkshire (GB)

(72) Inventor: Philip HEAD, Berkshire (GB)

(21) Appl. No.: 18/687,255

(22) PCT Filed: Sep. 2, 2022
(86) PCT No.: PCT/GB2022/052243

§ 371 Date: Feb. 27, 2024

(30) Foreign Application Priority Data
Sep. 2, 2021 (GB) 2112492.0

(51) Int. Cl. E21B 29/10; E21B 17/10; E21B 36/00; E21B 36/04; F16L 55/165

(52) U.S. Cl. CPC E21B 29/10; E21B 17/10; E21B 36/008; E21B 36/04; F16L 55/1657

(57) ABSTRACT

A method of sealing a casing comprising the steps of deploying a thin wall tube in the region the casing is to be sealed, melting a low temperature alloy and allowing it to flow into the annulus between the thin wall tube and the casing, and allowing the low temperature alloy to solidify. The thin wall tube may include protrusions on its outer surface, of similar height so as to centralise the thin wall tube in the casing.

In the oil and gas industry, a well is drilled to a subterranean hydrocarbon reservoir. A casing string is then run into the well and the casing string is cemented into place. The casing string can then be perforated and the well completed to the reservoir. A production string may be concentrically placed within the casing string and production of the hydrocarbons may begin, as is well understood by those of ordinary skill in the art.

During the drilling, completion, and production phase, operators find it necessary to perform various remedial work, repair and maintenance to the well, casing string, and production string. For instance, holes may be created in the tubular member accidentally or intentionally. Alternatively, operators may find it beneficial to isolate certain zones. Regardless of the specific application, it is necessary to place certain down hole assemblies such as a liner patch within the tubular member, and in turn, anchor and seal the down hole assemblies within the tubular member.

Numerous devices have been attempted to create a seal and anchor for these down hole assemblies. For instance, in U.S. Pat. No. 3,948,321 entitled “LINER AND REINFORCING SWAGE FOR CONDUIT IN A WELLBORE AND METHOD AND APPARATUS FOR SETTING SAME” to Owen et al, a method and apparatus for emplacing a liner in a conduit with the use of swage means and a setting tool is disclosed. The Owen et al invention anchors and seals the liner within the wellbore.

Despite these advances, the prior art suffers from the ability to properly anchor the down hole assembly into the tubular member. Also, the prior art devices do not properly seal within the tubular members. Therefore, there is a need for a device that will properly set, anchor and seal within a tubular member.

It is the purpose of the present invention to provide a convenient method of sealing a casing and/or perforations.

Accordingly, the invention provides a seal for a thin wall steel tube to the previous casing to form an all metal to metal casing patch

According to a further aspect of the invention there is provided a low temperature alloy to bond and seal a thin wall steel tube to the previous casing to form an all metal to metal casing patch

According to a further aspect of the invention the thin wall tube has protrusions plasma sprayed on its OD to provide stand-off.

According to a further aspect of the invention the stand-offs could be made from shape memory alloy and when gets above its transition temperature centralises the patch perfectly, regardless of the well inclination

According to a further aspect of the invention, an all-metal petal type centralizer, could both centralize the steel tube and be reciprocated at the place it is to be positioned to clean the surface of the previous casing

According to a further aspect of the invention the all metal petal could be coated with tungsten carbide to provide a hard cleaning surface

According to a further aspect of the invention the casing patches can be stacked to form a continuous patch.

According to a further aspect of the invention the bismuth is the anchoring means of locking the casing patch to both the previous casing and the patch itself

According to a further aspect of the invention the bismuth anchors to the protrusions of the outer surface of the casing patch

According to a further aspect of the invention the bismuth anchors into the perforations it is sealing

According to a further aspect of the invention the bismuth can be remelted to enable disassembly and removal of the patch.

According to a further aspect of the invention a drain port is provided to enable the bismuth to be emptied from the chamber.

According to a further aspect of the invention, different melting points of bismuth alloys can be selected depending on the anticipated static well bore temperature.

According to a further aspect of the invention different alloys can be selected to have different melting points

According to a further aspect of the invention lead can be used as the encapsulant for applications above 270 C which is the melting point of pure bismuth

According to a further aspect of the invention an electric heater is used to heat the patch and the bismuth store

According to a further aspect of the invention a two stage electric heater could be used to first deploy a lower seal/centraliser and the second to heat the patch and melt the bismuth

According to a further aspect of the invention a thermite heater could be used to heat the patch and melt the bismuth

According to a further aspect of the invention the bismuth can be pre cast onto the OD of the patch to a diameter not larger than the smallest restriction in the well

According to a further aspect of the invention the bismuth may be cast to the running tool

According to a further aspect of the invention the lower seal is a cup seal

According to a further aspect of the invention the lower seal is a coil spring

According to a further aspect of the invention the bismuth can seal eccentric annuli

According to a further aspect of the invention the patch does not need to be centralised to achieve a pressure tight seal

According to a further aspect of the invention in a deviated well it will be beneficial for the patch to rest on the low side as it will enable toolstrings easily to slide into the patch ID and not hang up on the upper face

According to a further aspect of the invention the bismuth can form a ramp on the low side to enable a tool string easily to slide into the patch ID and not hang up on the upper face

References to low temperature alloy herein refer to either low temperature alloy or pure metal which may be melted at a comparatively low temperature but which resolidifies at temperatures above the wellbore temperature; such low temperature alloys may include bismuth and/or lead.

The following is a more detailed description of embodiments according to the invention by reference to the following drawings in which:

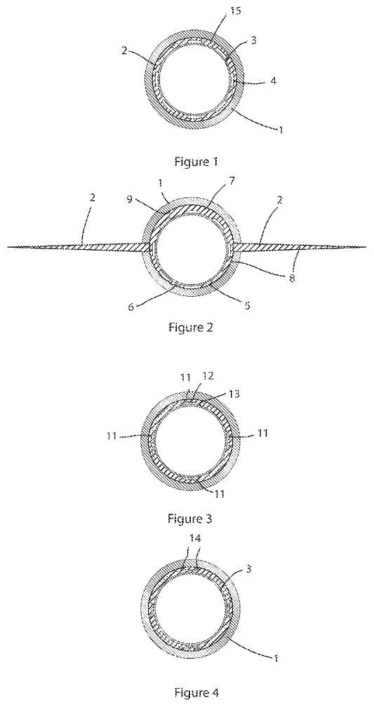

FIG. 1 is a section end view of a well casing with a casing patch perfectly centred and the annulus space filled with low temperature alloy

FIG. 2 is a similar view to FIG. 1 with the casing patch resting on the low side with protrusions bonded on its outside providing it a minimum standoff

FIG. 3 is a similar view to FIG. 1, with a shape memory alloy stand-off bonded to the outside of the casing patch.

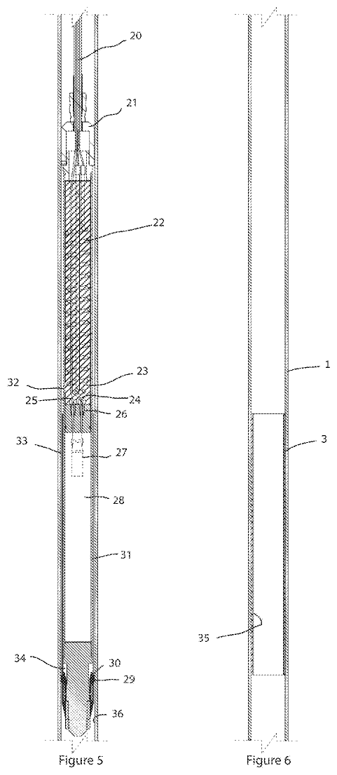

FIG. 4 is a similar view to FIG. 3 with the shape memory alloy stand off above its transition temperature and its shape changed to centralise the casing patch.

FIG. 5 is a section side view of the well with one embodiment of the casing patch running tool, installing the casing patch.

FIG. 6 is a similar view to FIG. 5 with the running tool removed and the casing patch bonded in place using the low temperature alloy

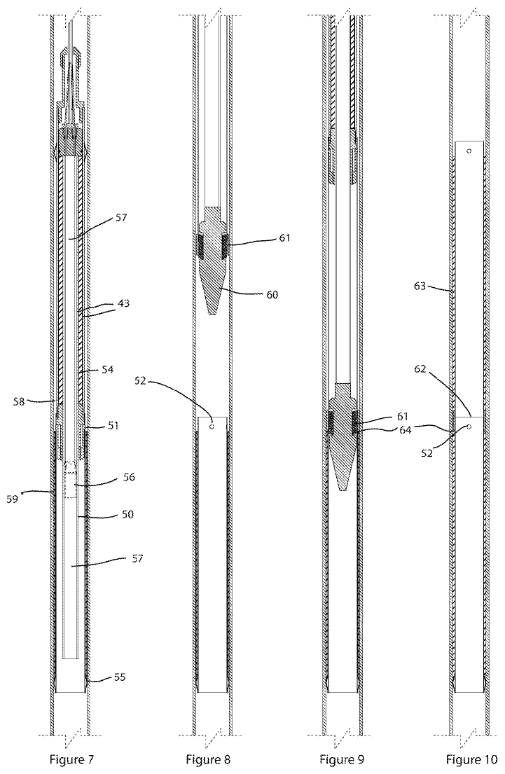

FIG. 7 is a section side view of the well with a second embodiment of the casing patch running tool, installing the casing patch.

FIG. 8 is a similar view to FIG. 7, with the first casing patch installed and a 2^{nd} casing patch being lowered, to be joined to the 1^{st} casing patch

FIG. 9 is a similar view to FIG. 8, with the 2^{nd} casing patch docked together with the first casing patch, and the junction sealed by a stinger assembly

FIG. 10 is a similar view to FIG. 9, with 2^{nd} casing patch running tool removed and the 1^{st} and 2^{nd} casing patched bonded in place by the low temperature alloy to form a continuous metal to metal seal casing patch from top to bottom

FIG. 11 is a section side view of the patch positioned across some perforations to be sealed, with a metal petal centraliser, sealing and centralising the bottom.

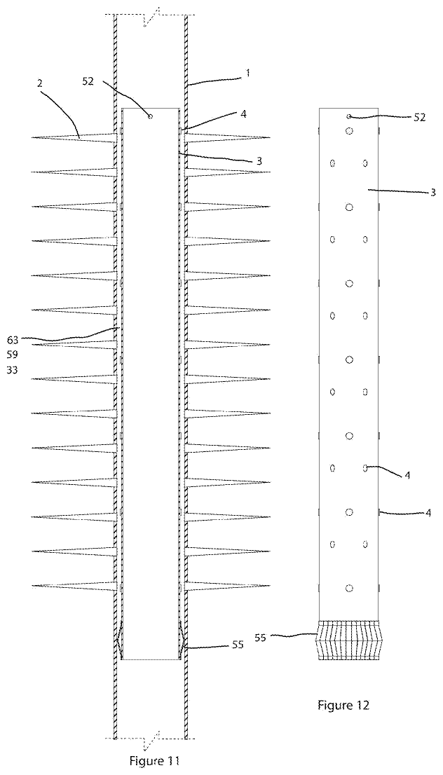

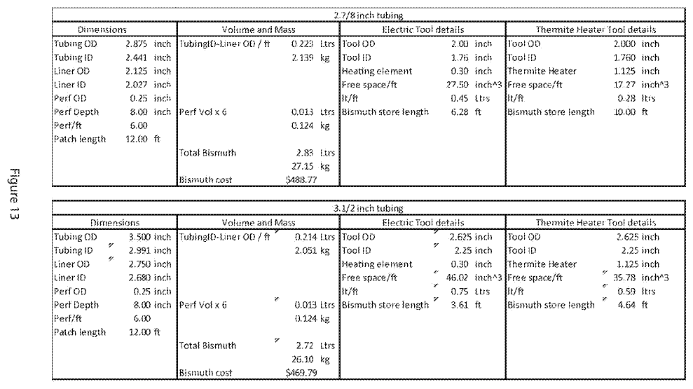

FIG. 12 is a view of a casing patch, with external protrusions and the metal petal centraliser at its lower end

FIG. 13 is a table providing the dimensions, volumes, and lengths of the running tool for typical tubing sizes

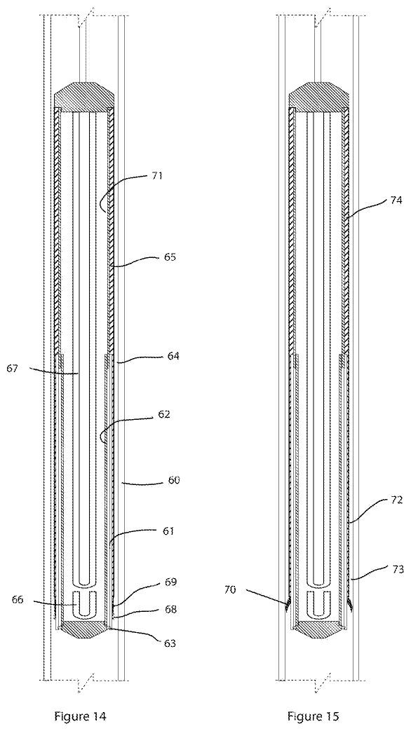

FIG. 14 is a section side view of well casing with a further embodiment of a electric heater running tool, casing patch and bismuth

FIG. 15 is a similar view to FIG. 14 with the lower centraliser/seal deployed.

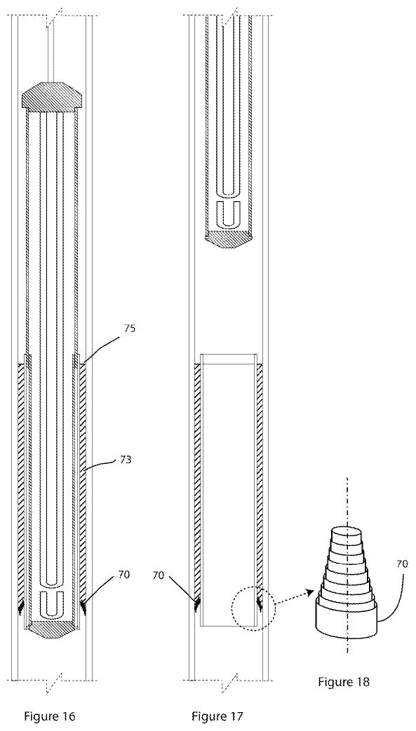

FIG. 16 is a similar view to FIG. 15 with the bismuth melted from the outside of the running tool and patch and accumulated in the annular space between the patch and casing

FIG. 17 is a similar view to FIG. 16 with the running tool removed.

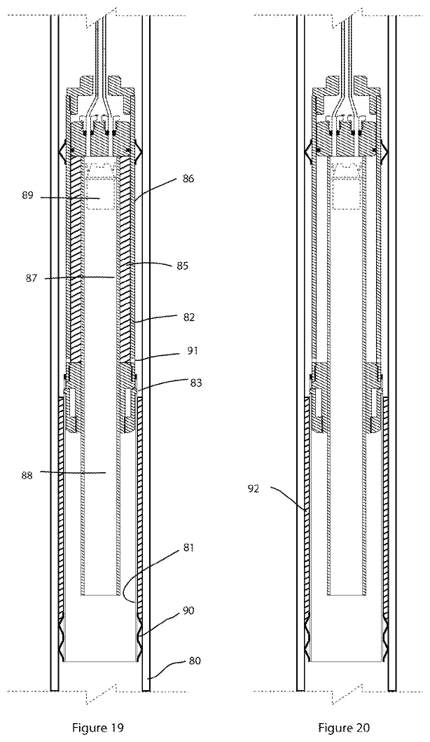

FIG. 18 is a detailed view of the coil spring used to centralise and seal the lower end of the patch.

FIG. 19 is a section side view of well casing with a further embodiment of a thermite heater running tool, casing patch and bismuth

FIG. 20 is a similar view to FIG. 19 with the bismuth melted and situated in the annular space between the casing and the patch.

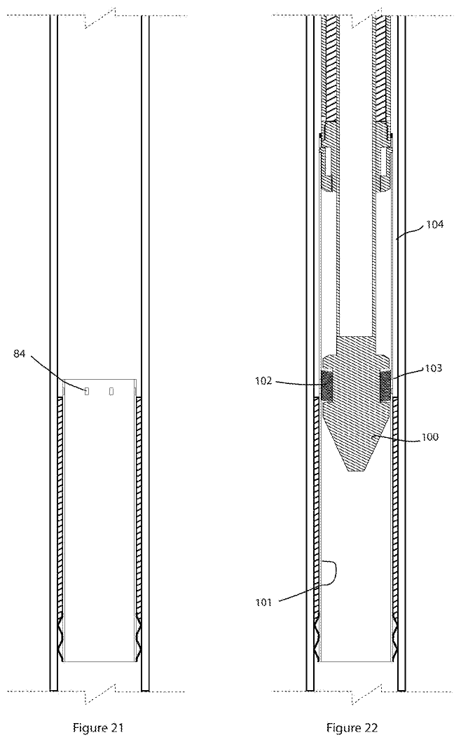

FIG. 21 is a similar view to FIG. 20 with the running tool removed and the patch sealed to the casing by the bismuth

FIG. 22 is a similar view to FIG. 21, with a 2^{nd} patch being installed to extend the first patch

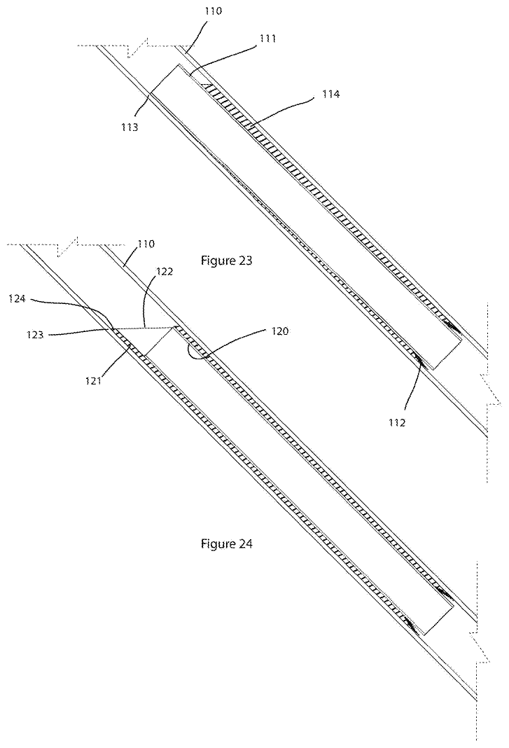

FIG. 23 is side view of a deviated well with the patch not centred and the upper surface resting on the low side of the casing with the eccentric annulus filled with bismuth

FIG. 24 is a similar view to FIG. 23, with the patch centralised and surplus bismuth providing a ramp on the low side of the upper surface of the patch.

Referring to FIGS. 1 to 4

There is shown a well casing 1, with perforations 2 to be isolated. A casing patch is provided, consisting of a thin wall tube 3 with external protrusions 4 bonded to the outside surface of the tube 3, or plasma sprayed onto the surface so as to get a very good bond between the protrusion and the thin wall tube. The maximum diameter of these protrusions is dictated by the minimum restriction (shown by the dotted line 15) the thin wall tube has to go through.

FIG. 1 is an ideal case with the thin wall tube perfectly centralised, while FIG. 2 is a more realistic case where the tube 3 rests on the low side 5 and the protrusions providing some stand-off 6 and thus act as a centraliser, but the tube is still eccentric 7 to the well casing 1. This is not a problem, as the entire eccentric space is filled with molten low temperature alloy 8, such as bismuth or a bismuth based alloy, by a process to be described below.

The low temperature alloy flows into the perforations 2 and fills the space between the outside of the thin wall tubing 3 and the ID 9 of the well casing. When the low temperature alloy is allowed to cool down it solidifies and forms a solid metallic mass 10, providing a metal-to-metal seal of the thin wall tube to the casing and anchors both to the well bore casing and perforations and to the outside of the thin wall tube and around all the protrusions.

FIGS. 3 and 4 show another embodiment of centralisers, each centraliser 11 is made from shape memory alloy, a suitable alloy is chosen so that it transitions at a selected temperature. The centre 12 of each centraliser 11 is bonded to the thin wall tube, and its outer “Wings” 13 are free, and at the transition temperature change shape to the cup shape 14 that they were heat treated to. In effect they perfectly centralise the thin wall pipe 3 relative to the well casing 1.

Referring to FIGS. 5 and 6 there is shown an embodiment of casing patch running tool. It consists of a wireline 20 that conveys to tool assembly into the well. It has a connector 21 which joins the tool to the wireline. In the upper section of the tool is an electric heating element 22, around which is a solidified low temperature alloy 23. Two additional wires 24,25 go through a bulkhead 26 and connect to an ignitor 27, which is embedded into a blend of thermite and 15% sand 28. The sand retards the thermite reaction and when required this section provides controlled heat to the thin wall tubing. At the bottom of the tool is a cup seal 29, which can flex and pass thought any restriction above where the patch is to be set, but where the patch is to be set, the cup is in contact with the ID 36 of the casing and the lower surface 30 of the thin wall tube.

The sequence of operation is as follows;
1. Lower the tool to the correct depth, the running tool would include casing collar locator and other standard tools
2. The thermite ignitor 27 would be activated, this is turn would cause all the thermite 28 inside the housing 31 to react and quickly go to a high temperature, 600 C, this pre-heat the thin wall tube and well casing, the centralisers and the perforations.
3. The electric head would be turned on and lower temperature alloy will melt in a controlled way and flow out of ports 32 into the annular space 33 between the well casing and the outside of the thin wall tube.
4. The temperature will be monitored, and when below the solidification temperature of the low temperature allows, an over pull can be applied from surface so that the cup 29 collapses inwardly into the space provided 34 and slides up the inside 35 of the thin wall tube so that the running tool can be retrieved back to surface, leaving the thin wall tube 3 secured in place in the well casing 1, sealing the annular space 33 between the well casing and the outside of the thin wall tube, and any perforations in that region as shown in FIG. 6.

Referring to FIGS. 7 to 10, there is shown a 2^{nd} embodiment of the invention. A central tube 50 in the tool extends from top to almost the bottom of the thin wall tube it is conveying. The tool is attached to the top of the thin wall tube via a collet 51 which locates in holes 52 in the thin wall tube. Above the collets is an annular chamber 53 which contains solidified low temperature alloy 54. At the bottom of the thin wall tube is a metal petal basket 55 which centralizes the lower end of the tool assembly in the casing 1. In addition, it seals the lower end of the thin wall tube to the ID of the casing 1. At the upper end of the running tool is centraliser, which keeps the upper end of the tool assembly centralised.

The sequence of operation is as follows;
1. Lower the tool to the correct depth, the running tool would include casing collar locator and other standard tools
2. The thermite ignitor 56 would be activated, this is turn would cause all the thermite 57 inside the housing 50 to react and quickly go to a high temperature, 600 C, this pre-heat the thin wall tube and well casing, the centralisers and the perforations, and also heats the low temperature alloy 54
3. The low temperature alloy will melt in a controlled way and flow out of ports 58 into the annular space 59 between the well casing and the outside of the thin wall tube.
4. The temperature will be monitored, and when below the solidification temperature of the low temperature alloy, an over pull can be applied from surface and the collets 51 will collapse and release from the holes 52 at the upper end of the thin wall tube, and the running tool will be recovered to surface.

To extend the length of the patch, a second patch can be docked into the first patch. Referring to FIGS. 8 to 10, at the lower end of the new running tool is a tapered nose stinger 60, which enables both patches to be aligned perfectly. Chevron packing 61 on the stinger seals the junction 62 where the two patches join and the holes 52. The same sequence of operation is performed as previously described to enable the low temperature alloy to flow into the annular space 63 around the second casing patch, and its also bonds to the top 64 of the first casing patch.

This achieves a metal-to-metal seal casing patch from the bottom of the first patch to the top of the 2^{nd}, clearly this can be repeated as often as required.

Referring to FIGS. 11 and 12 it is shown in more detail the perforations 2 to be sealed and the casing patch 3 which its external protrusions 4, and the petal basket 55 at its lower most end.

FIG. 13 details two casing sizes and the casing patch size and the typical quantity of low temperature alloy required, it also shows the tool length to carry the required volume of bismuth.

Referring to FIGS. 14 to 18 there is shown another embodiment of the invention, a casing 60 requires a patch, a patch 61 is conveyed on a running tool 62, the running tool extends to the bottom of the patch and supports the patch using collets 63, the annular space between the OD of the patch and the ID of the casing 64 has to be filled with bismuth 65. Inside the running tool are two electric heaters 66,67, the lower heater 66 is first turned on to release a meltable lock holding a spring coil 69 in its collapsed state, when the lock is melted the coil spring can extend to its expanded state 70. A pull test can be performed to confirm the centraliser/seal is deployed.

Next the upper electric heater 67 is turned on, this heats virtually the entire running tool length, and heats the patch 61 and the running tool body 71, bismuth bonded to the outside of the patch 72 melts and accumulates in the annular space 73, similarly a larger volume of bismuth 74 melts and flows into the annular space 73. The total volume of bismuth is less than the total volume of the annular space 73, this is for two reasons, to allow the patch to be fitted in deviated wells without the bismuth over flowing 75.

The temperature of the running tool body 71 is measured to confirm the melting of the bismuth, and a density sensor at the patch itself confirms all the melted bismuth is in the annular space 73. The upper heater can be turned off and once the temperature is below the melting point of the bismuth, and a pull test can be performed to confirm this. A second pull will release the collets 63, and the running tool can be removed to surface.

Referring to FIGS. 19 to 22 there is shown another embodiment of the invention, a casing 80 requires a patch, a patch 81 is conveyed on a running tool 82, the running tool connects to the patch using a collect 83 secured into recesses 84, bismuth 85 is stored in a chamber between a outer housing 86 and an inner housing 87. Inside the inner housing 87 is thermite 88 At the upper end of the chamber is an thermite ignitor 89.

At the lower end of the patch is a double springy seal 90, when at the required setting depth electrical power (14V 20 amps) is supplied to the ignitor 89, after about e.g. 10 seconds the ignitor is set off and this in turn sets of the thermite. The thermite extends virtually the full length of the tool, it preheats the patch and casing and melts the bismuth 81, this drains out of holes and flows into the annular space 92 to seal the patch to the casing.

Once cooled down a pull test can be performed to confirm the bismuth is set and the running tool can be disconnected from the patch and pulled out of the hole

If the patch needed to be extended, a 2^{nd} and 3^{rd} patch can be run. This consists of the same running tool being deployed, with a stinger 100 to engage the ID 101 of the patch with chevron packing 102 to seal the interface between the two patches. The same process is followed to melt the bismuth and its flows into and sets in the annular space 104. This can be repeated as often as required.

Refering to FIGS. 23 and 24 there is shown deviated casing 110, with a casing patch 111 centralized at its lower end by the coil spring centraliser and seal 112 and resting on the lower side at its upper end 113, with the eccentric annulus filled with bismuth 114, in this configuration a future tool string run in the well would slide easily into the patch ID as there is minimum lip for the tool string to hang up on.

Alternatively, the patch 120 could be set centralized during the bismuth setting process, excess bismuth would be deposited which would extend above the patch 121, the upper surface being level 122 and relative to the casing 123 would provide a ramp 124 for a future tool string to enter the ID of the patch without hanging up.

1. A method of sealing a casing comprising the steps of:
deploying a thin wall tube in the region the casing is to be sealed;
melting a low temperature alloy and allowing it to flow into the annulus between the thin wall tube and the casing; and
allowing the low temperature alloy to solidify.

2. A method according to claim 1, wherein the thin wall tube includes protrusions on its outer surface.

3. A method according to claim 2, wherein the protrusions are of similar height so as to centralise the thin wall tube in the casing.

4. A method according to either claim 2, wherein the protusions are plasma sprayed on the thin wall tube.

5. A method according to claim 1, wherein centralisers comprised of shape memory alloy are provided, wherein the centralisers adopt a shape that stands off the thin wall tube from the casing when a transition temperature is exceeded.

6. A method according to claim 1, wherein a petal type centralizer is provided.

7. A method according to claim 6, wherein the petal type centralizer is coated with tungsten carbide.

8. A method according to claim 1, wherein a plurality of casing patches are stacked to form a continuous patch.

9. A method according to claim 1, wherein the low temperature alloy is remelted to enable disassembly and removal of the patch.

10. A method according to claim 1, wherein the low temperature alloy is deployed in a chamber of a running tool, and emptied from a drain port.

11. A method according to claim 1, wherein the melting points of the low temperature alloy is be selected depending on the anticipated static well bore temperature.

12. A method according to claim 1, wherein the low temperature alloy is lead.

13. A method according to claim 1, wherein the low temperature alloy is bismuth.

13.

14. A method according to claim 1, wherein a two stage electric heater is provided, including the steps of heating to deploy a lower seal/centraliser and a second heating step to heat the patch and melt the low temperature alloy.

15. A method according to claim 1, wherein a thermite heater is provided.

16. A method according to claim 1, wherein low temperature alloy can be pre cast onto the OD of the thin wall tube.

17. A method according to claim 1, wherein a running tool is employed and the low temperature alloy is cast to the running tool.

18. A method according to claim 1, wherein a lower seal is provided.

19. A method according to claim 18, wherein the lower seal is a cup seal.

20. A method according to claim 18, wherein the lower seal is a coil spring.

21. A method according to claim 1, wherein the casing to be sealed is deviated or the annuli between the thin wall tube and the casing is eccentric, wherein the thin wall tube is permitted to rest on its lower side.

22. An apparatus for patching a casing according to claim 1, comprising a running tool bearing a low temperature alloy.

23. A method according to claim 1, wherein an electric heater is used to heat the patch and the deployed low temperature alloy.
